(19) United States
(12) Patent Application Publication
(10) Pub. No.: US 2021/0224791 A1
(43) Pub. Date: Jul. 22, 2021

(54) METHOD AND SYSTEM FOR CONTROLLING FEEDBACK COMMUNICATION TO A USER DURING AN ELECTRONIC INTERACTION

(71) Applicant: Loyalty Angels Ltd, Ascot, Berkshire (GB)

(72) Inventor: David Ian Gower, Ascot, Berkshire (GB)

(21) Appl. No.: 17/059,824

(22) PCT Filed: Jun. 5, 2019
(86) PCT No.: PCT/GB2019/051553

§ 371 Date: Nov. 30, 2020

(30) Foreign Application Priority Data
Jun. 5, 2018 (GB) 1809223.9

(51) Int. Cl. G06Q 20/36; G06F 3/01; G06Q 20/32; G06Q 20/42

(52) U.S. Cl. CPC G06Q 20/3672; G06Q 20/42; G06Q 20/3278; G06F 3/016

(57) ABSTRACT

A method for providing improved feedback to a user during an electronic contactless interaction between a first contactless device and a second contactless device, where at least one of the first contactless device and the second contactless device is associated with a specific user, is described. The method comprises: receiving interaction data relating to the electronic contactless interaction, the data including at least an outcome of the contactless interaction and information identifying the user; determining, using the received interaction data, user preference data associated with the user; generating a control signal based at least on the outcome of the electronic contactless interaction and on the user preference data, the control signal configured to cause at least the first contactless device to generate feedback in dependence on the outcome and the user preference data; and outputting the control signal to at least the first contactless device.

### TECHNICAL FIELD

The present disclosure relates to methods and systems for controlling feedback communication to a user during an electronic interaction. More particularly, though not exclusively, the present disclosure relates to methods and systems for providing improved audio and haptic feedback to users during a near-field interaction using at least one electronic device.

### BACKGROUND

It is becoming more common for consumers to utilise a digital wallet to transfer money for goods and/or services. A digital wallet is typically an electronic device that allows a user to make transactions electronically. The electronic device is typically a mobile telecommunications device, such as, for example, a smartphone, and will generally employ near-field communication (NFC) or a similar short-range communication protocol to enable swift, contactless payment.

To be able to perform electronic transactions using a digital wallet, a consumer, or user, is required to upload information relating to their physical Payment Card(s) to a digital wallet payment system using a digital wallet application (such as Apple Pay, Google Pay) operating on the electronic device.

In the digital wallet application, the Payment Card is represented using an image. If multiple Payment Cards are registered with the digital wallet application, they are represented in list form, and one of the registered Payment Cards, which has been selected by the user to be the default Payment Card, is displayed at the top of the list.

When the user makes a transaction via NEC using the device as a digital wallet, the default Payment Card is used for payment. At a Point of Sale (PoS), the user enables the device NFC, and presents the device to a payment terminal that also has NEC enabled at an NFC reader. A wireless (and contactless) interaction is performed between the device and the payment terminal using the NEC protocol. The user subsequently receives a standard confirmatory audio or vibration notification from the mobile device when the transaction has been completed. A visual notification is also typically provided by both the mobile device and the payment terminal.

The audio or vibration notification emitted by the mobile device allows the user to know that the wireless interaction between the payment terminal and the mobile device has been successfully completed. The user can then remove the mobile device from the proximity of the payment terminal and its NFC reader knowing that the interaction has completed. Similarly, the visual notifications also allow the user to understand when an interaction has completed, separately from the audio or vibration notification.

Both visual and audio or vibration notifications are useful for users in different environments and different circumstances. Some users typically rely on the visual notification only, while some users use the audio notification to identify when the interaction is complete. However, in some environments, particularly busy shopping environments, it may sometimes be difficult to discern either notification, causing confusion and delay at the PoS for both the user and a PoS operator, if present.

Additionally, the main advantage of using digital wallets in lieu of a physical payment card is supposedly speed and convenience. Digital wallets reduce the number of items required to be carried by the user, and are both secure and easy to use. Payment cards in digital wallets can be accessed without having to navigate through the graphical user interface (GUI) of the device to find the specific application—many electronic devices now include shortcuts to quickly enable NFC with a selected card, for example a double press of a button on a smartphone.

However, in current implementations of digital wallet applications, a user cannot access information relating to their transactions unless they unlock their electronic device, search through their applications using their GUI until they have found the digital wallet application, open the digital wallet application on their device, and select the option relating to transactions, requested information regarding recent transactions and then find the applicable transactions. This is a particularly time-consuming and problematic user-navigation journey through their GUI, especially given that the main advantage of digital wallet applications is their speed and convenience. Users may be dissuaded from using digital wallets because of the clunky user-navigation journey required to arrive at transaction information.

It is against this background that the present invention has been devised. Specifically, though not exclusively, the present invention seeks to provide a retrofitting solution which can work with existing legacy systems.

### SUMMARY OF THE INVENTION

According to one aspect of the present invention there is provided a method for providing improved feedback to a user during an electronic contactless interaction between a first contactless device and a second contactless device, wherein at least one of the first contactless device and the second contactless device is associated with a specific user, the method comprising: receiving interaction data relating to the electronic contactless interaction, the data including at least an outcome of the contactless interaction and information identifying the user; determining; using the received interaction data, user preference data associated with the user; generating a control signal based at least on the outcome of the electronic contactless interaction and on the user preference data, the control signal configured to cause at least the first contactless device to generate feedback in dependence on the outcome and the user preference data; and outputting the control signal to at least the first contactless device.

By linking the contactless interaction data feedback with user preference data, each control signal can be personalised to provide invention for each user. This personalisation is hugely beneficial in that it enables a way in which information relating to the transaction for that particular user to be conveyed. That information can also be encoded using the user preference data to ensure that only the user themselves understands what the audio file generated from the control signal actually means (see later). Also by use of a control signal, the user is presented with not only a confirmation that the contactless transaction has been completed, but also (where the user is using a digital wallet for example) that there is no need to navigate through the various screens of the user device to understand further information about the transaction.

The method in certain embodiments may further comprise, prior to the electronic contactless interaction; receiving a user selection relating to user preference data and associating the user preference data with a user entry in a data store, and wherein determining the user preference data comprises receiving the user preference data from the data store.

In one embodiment the data store is an external data store; and wherein the user preference data is received with the interaction data. In another embodiment the data store is a local data store, and the step of receiving the user preference data from the data store comprises accessing the data store and identifying user preference data based on the information identifying the user. In either embodiment; the user preference data may comprises metadata.

The electronic contactless interaction is in some embodiments a contactless payment transaction and wherein the step of receiving interaction data comprises receiving an authorisation response that includes the data relating to the electronic contactless interaction.

In this case, the step of receiving interaction data may comprise receiving information identifying the user in the form of a payment card identifier, and wherein the determining step comprises comparing the payment card identifier with stored data relating to a plurality of users and identifying the user-data corresponding to the payment card identifier.

In some embodiments, the step of receiving interaction data comprises receiving information identifying the user in the form of a PAN (Primary Account Number), a truncated PAN, or a tokenised PAN.

The method may include providing improved feedback to a user during an electronic contactless interaction between the first and second contactless devices, where the first and second contactless devices comprise near-field communication (NFC) devices. In this case the first contactless device may comprise an electronic device configured to operate as a digital wallet and the second contactless device comprises an NFC reader connected to a wider payment system. Furthermore, in this embodiment the electronic device is preferably a smartphone.

In other embodiments, the first contactless device comprises an NFC reader connected to a wider payment system, and the second contactless device comprises a contactless payment card. Accordingly, the present invention has applicability beyond digital wallets.

In some embodiments, the generating step comprises generating a control signal configured to cause at least the first contactless device to generate feedback in the form of audio and/or haptic feedback.

In some embodiments the method further comprises receiving the control signal at the first contactless device and generating the feedback according to the control signal.

In this case, the step of generating the feedback according to the control signal comprises identifying data stored locally on the first contactless device based on the control signal and generating feedback using the identified data.

The method in some embodiments may further comprise initiating the electronic interaction between the first and second devices, and receiving the data relating to the electronic contactless interaction during the interaction.

The generating step comprises generating a control signal configured to cause at least the first contactless device to generate feedback in the form of audio and/or haptic feedback, feedback being in an encoded form the meaning of which the user understands from the user preference data.

In some embodiments, this notification is generated and broadcast for anyone in the vicinity of the device to hear. In these embodiments, the notification needs effectively to be encoded. For example, an audible notification which is in the form of a person speaking providing information would not be suitable as a solution to the present problem because that sensitive information would be disclosed to anyone listening at that time. The present invention effectively creates an audible notification which has a known meaning to the user, as it is in a form predetermined or known to the user. This is a form of encoding of the notification. Also advantageously, to improve security, the audible notification can be configurable to different meanings such that the user can change the audible notifications having a particular desired meaning.

In this way, the present invention advantageously increases the entropy of the communication between the electronic device and the user by providing more information specific to the interaction which has just occurred between the electronic device and any external device, typically an NFC reader. This can be achieved in some embodiments without increasing the duration of the communication as different audible sounds (having the same duration of typically 0.5 seconds) for example have different meanings. In terms of variables of the audible sound notification, the pitch (or frequency) can be changed as can the composition of the frequencies used for the notification. It is preferable for the amplitude (volume) of the audible notification to remain constant for notifications having different meanings. This ensures advantageously that users with poor hearing can be assured to hear all of the composition of the notification in dependence upon the local audio volume level setup of their electronic device. Similarly, the duration of the notification is preferably constant in order to enable the user to recognise that the notification relates to feedback of the transaction rather than any other sound which may emanate from the electronic device. For example, if a smartphone is being used and a text message or email is received at the same time as a user interaction with an NFC device is happening, the text/email notification will typically have a different duration in time to the audible notification generated in response to the interaction of the smartphone with the NFC reader. It may also have a different composition; however the duration difference can help to distinguish a class of notifications belonging to the feedback of current interaction with external devices as opposed to a class of notification messages relating to information being received by the smartphone.

The present invention also extends to a system for providing improved feedback to a user during an electronic contactless interaction between a first device and a second device, wherein at least one of the first device and the second device is associated with a specific user, the system comprising: a central processing system operatively connected to a communications network and configured to: communicate with at least the first device via the communications network; receive interaction data relating to the electronic contactless interaction, the data including at least an outcome of the contactless interaction and information identifying the user; determine, using the received interaction data, user preference data associated with the user; generate a control signal based at least on the outcome of the electronic contactless interaction and on the user preference data, the control signal configured to cause at least the first contactless device to generate feedback in dependence on the outcome and the user preference data; and output the control signal to at least the first contactless device.

In some embodiments the system comprises the first device operatively connected to the communications network and configured to communicate with the central processing system and to generate feedback in dependence on the control signal.

The system may further comprising at least one payment processing system, the payment processing system operatively connected to the communications network and configured to communicate with at least the central processing system and to communicate the data relating to an electronic interaction to the central processing system.

In some embodiments, the payment processing system and central processing system are separate.

In some embodiments the payment processing system comprises at least one point-of-sale (PoS) terminal, a payment service provider (PSP) server, and a payment card provider (PCP) server.

According to another aspect of the present invention there is provided an electronic device for providing improved feedback to a user during an electronic contactless interaction between the device and another device, the electronic device comprising: an application for generating an electronic wallet; a processor configured to interact with the central processing system described above; a receiver for receiving the control signal; and a generator for generating an audio and/or haptic response in accordance with the received output control signal.

Ideally, the electronic device is arranged to associate with a user account the data extracted from a set of data-bearing media. Advantageously, this enables payment cards and specific audio notifications to be linked to the same user account, and thereby enables payment transaction status information to be relayed to the consumer by those specific audio notifications.

### BRIEF DESCRIPTION OF THE DRAWINGS

One or more embodiments of the invention will now be described, by way of example only, with reference to the accompanying drawings, in which:

FIG. 1 is a schematic block diagram a system for performing transactions with a digital wallet and for providing point-of-sale feedback to a user of the digital wallet according to an embodiment of the present invention;

FIG. 2 is a schematic block diagram of the electronic device used in the system of FIG. 1,

FIG. 3 is a schematic block diagram showing interaction between the electronic device of FIG. 2 and a payment system;

FIG. 4 is an interaction diagram illustrating an exemplary method of the invention;

FIG. 5 is a flow chart detailing a method for enrolling a payment card for providing improved point-of-sale feedback according to an embodiment of the present invention; and

FIG. 6 is a flow chart detailing a method for providing point-of-sale feedback to a user of the digital wallet according to an embodiment of the present invention.

### DETAILED DESCRIPTION OF EMBODIMENTS

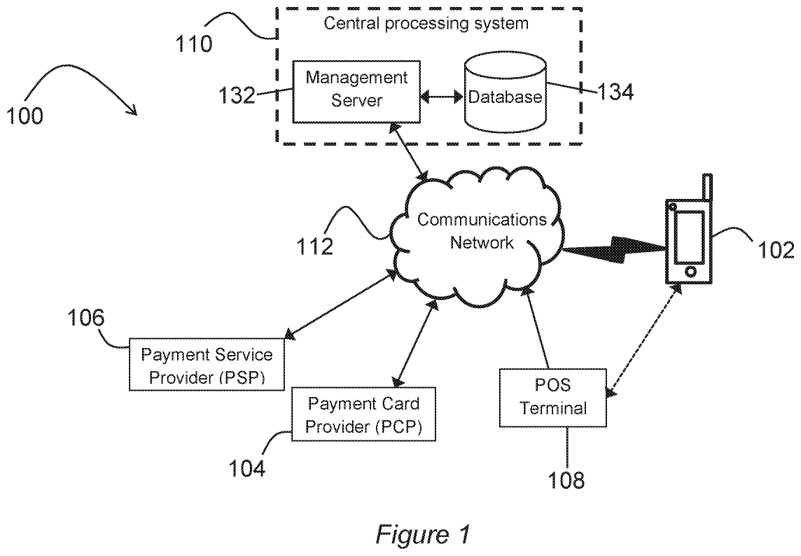

An example system 100 according to an embodiment of the invention is illustrated in FIG. 1. The system 100 is configured to provide improved point-of-sale feedback to digital wallet users.

The system 100 includes: an electronic device 102 that acts as a digital wallet; at least one payment card provider 104 (PCP); at least one payment service provider 106 (PSP); at least one point of sale (PoS) terminal 108; and a central processing system 110.

Each of the electronic device 102, PCP 104, PSP 106, PoS terminal 108, and central processing system 110 is connected to and/or capable of communication with a communications network 112. The communications network 112 is typically a wide-area network such as the Internet, for example; which connects various parties involved in the implementation of the embodiment and provides network infrastructure for the exchange of data.

As shown by the dotted arrow between the electronic device 102 and the PoS terminal 108, the PoS terminal 108 and electronic device 102 are also capable of communicating. The communication between the PoS terminal 108 and the electronic device 102 is via a near-field communication (NFC) protocol or another short-range wireless (contactless) communications protocol. References to NFC herein should be regarded as being a reference to the NFC protocol or to any other suitable short-range wireless (contactless) communication protocol.

It will be appreciated that references to communications by the PSP 106 and PCP 104 are enacted by respective communications modules 122 housed within computer systems of the PSP 106 and PCP 104 respectively. The computer systems, typically servers, process authorisation requests, control access to user databases, compare authorisation requests with user databases, communicate with each other and other parties to the system 100; and communicate authorisation responses. The PSP 106, as will be discussed later on, is in communication with the central processing system 110 directly and may also be in communication with the user's electronic device 102 directly, via, for example, one or more application programming interfaces at the PSP 106.

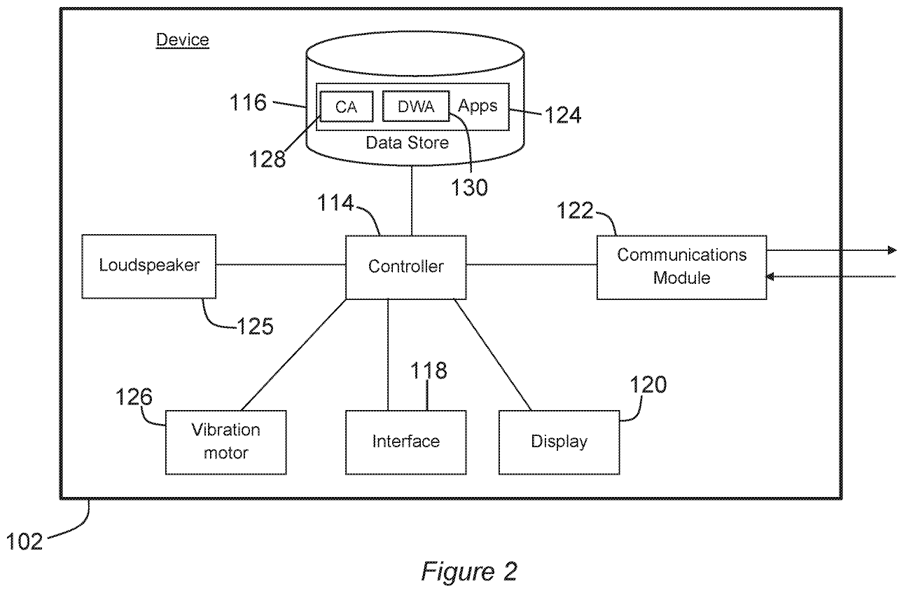

The electronic device 102, an example of which is shown in FIG. 2, is typically a mobile telecommunications device, such as a smartphone or a tablet computer. The electronic device 102 belongs to a respective user and is connected to the communications network 112 in order to upload data for processing to a management server according to a method as described herein.

As can be seen in FIG. 2, the electronic device 102 includes a controller 114 which in this embodiment is a microprocessor controlling the operation of the device 102. The device 102 also includes a data store 116, an interface 118, a display 120 and a communications module 122, each of which are connected to the controller 114 for communication therewith. The interface 118 may be integral with the display 120, for example, as a touch screen. The device 102 also has a loudspeaker 124, for providing audible notifications and feedback, and a vibration motor 126, also referred to as a vibration generator or vibrator, for providing feedback and notification in the form of vibrations. Both the loudspeaker 124 and vibration motor 126 are in communication with the controller 114.

The electronic device 102 may comprise additional feedback generators in addition to the loudspeaker 124 and vibration motor 126 such as a haptic feedback generator or other feedback generators capable of providing haptic, audio, or vibration feedback to a user of the electronic device 102. For example, feedback from a haptic touchscreen may be utilised as many smartphones used as digital wallets require the user to be in contact with the touchscreen during the transaction. Advantageously, haptic feedback is relatively inconspicuous, as the user alone is likely to receive the feedback. It will also be appreciated that feedback may also be combined with visual feedback generated according to the user's preferences, such as a sudden increase of brightness of the display 120, a particular graphic displayed on the display 120, or illuminating a notification lamp or camera lamp of the electronic device 102.

The controller 114 is configured to receive inputs from each of the data store 116, interface 118, and communications module 122, perform actions such as running applications and processing the inputs, and to output control signals to the loudspeaker 124, vibration motor 126, communications module 122, and display 120. The communications module 122 is operable to facilitate exchange of data with other processing elements shown in FIG. 1 via the communications network 112, or with the PoS terminal 108 via NFC, and so is capable of receiving data and communicating it to the controller 114, as well as receiving output data from the controller 114 and outputting it from the device 102 to the communications network 112 or PoS terminal 108.

At least one consumer application 124, 128 (‘app’) is stored within the data store 116, and is able to be run, or executed, on command by the controller 114 in a conventional manner. A digital wallet application 124, 130 is also stored within the data store 116. The consumer application 128 and digital wallet application 130 are both depicted in FIG. 2 as an ‘app’ 124 in the data store 116. Alternatively, in another embodiment, the consumer application 128 and/or the digital wallet application 130 can be provided as part of the operating system of the device 102. The consumer application 128 and digital wallet application 130 are installed on the device 102 so that they are stored in the data store 116 and executable by the controller 114 when desired. The digital wallet and consumer applications 130, 128 are downloadable from an application store and/or content provider. For example, the content provider may comprise the Apple® Appstore® or Google® Play®.

The applications are operable in combination to cause the controller 114 to output audio and/or vibration control signals according to preference information input to the consumer application 128 by the user, as will be described in more detail below.

The consumer application 128 comprises an application graphical user interface that is used to gather data from the user, particularly relating to user preferences, and to display data sent to the application by the central processing system 110 via the communications network 112. When the consumer application 128 is run by the controller 114, data is displayed to the user and data input to the device 102 via the interface 118 is interpreted according to the setup of the consumer application 128.

Data input to the consumer application 128 by the user can be uploaded via the communications network 112 to a centralized hub such as the central processing system 110 where it can be managed and processed, and responded to, by the central processing system 110.

The digital wallet application 130 is an application used by the user of the electronic device 102 to perform transactions with PoS terminals without the necessity for a physical payment card or token. The user registers a payment card or token with the digital wallet application 130 by inputting details of the physical payment card such as payment account number (PAN) and expiry date, and accepts the policies of the particular digital wallet application 130. The user gives consent for the digital wallet application 130 to use the details they have provided to perform interactions with other NEC-enabled devices in order to complete transactions from the user's bank account to the bank account of a merchant, when the user consents. The digital wallet application 130 may contain a plurality of registered payment cards. Each payment card is represented using a payment card image. If multiple payment cards are registered with the digital wallet application 130, they are represented in list form, and one of the registered payment cards, which has been selected by the user to be the default Payment Card, is displayed at the top of the list.

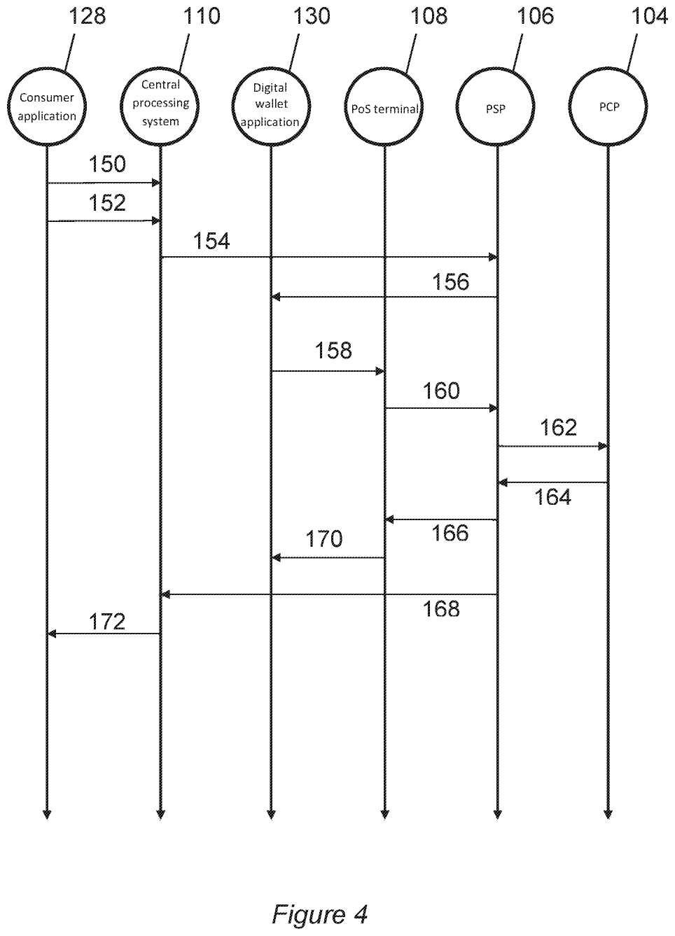

To initiate an interaction, the user accesses the digital wallet application 130 via the interface 118 and display 120, either using a shortcut specifically designed for initiating an interaction, or by navigating through the operating system of the device 102 and commanding the controller 114 to run the digital wallet application 130. The specific implementation of the interaction is described later with reference to FIG. 4.

Once the user has initiated the interaction, the device 102 can be brought close to an NFC reader, for example at the PoS terminal 108. The device 102 (which includes an NFC communications functionality within the communications module) and NFC reader communicate using the NFC protocol, transferring the relevant information for a transaction to be performed. The PoS terminal 108 and the device 102 subsequently notify the user when the interaction is complete using feedback in the form of an audible or haptic notification and/or a visual notification.

As discussed above, the methods and systems described herein are for the purpose of customising the feedback provided to the user by the electronic device 102 so that specific information relating to the transaction can be communicated to the user shortly after the interaction has taken place.

The digital wallet application 130 and consumer application 128 may be integral as a single application configured to perform both functions.

Returning briefly to FIG. 1, the central processing system 110 receives data sent via the communications network 112 and provides data to other systems connected to the communications network 112. The central processing system 110 comprises a management server 132 and a management database 134 stored in a data store 116. Data is received and processed at the central processing system 110 by the management server 132, which is operatively coupled with the management database 134. Data that is received by the management server 132, or data that is of use for the operation of the management server 132, may be stored in the management database 134. The management server 132 and management database 134 are external to the consumer application 128 and acts as an on demand service.

Although not shown in FIG. 1, the management server 132 may further comprise a communications module 122 for communicating and/or receiving data from the communications network 112, an encryption module for encrypting data before it is communicated, a decryption module for decrypting encrypted data communicated to the management server 132, a user registration engine for registering individual users and their associated devices, a user preferences engine for processing the preferences selected by a user using the consumer application 128, and a notification engine for generating signals and/or commands to be communicated to the electronic device 102 during a transaction process. Such structures of management servers are known in the art and so are not described in further detail herein.

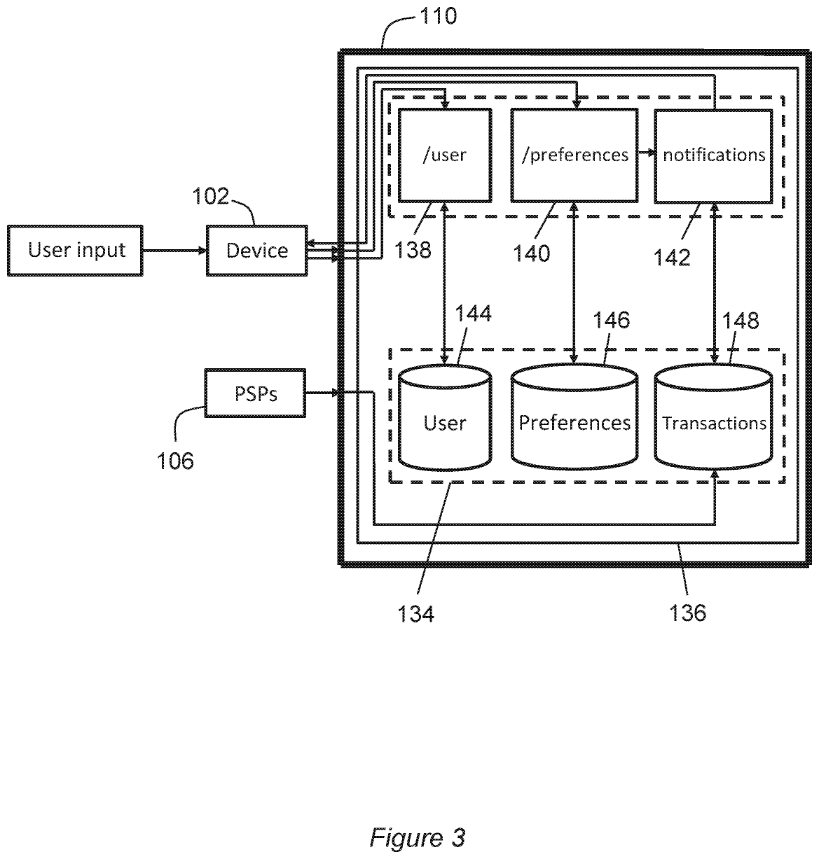

Referring now to FIG. 3, the relationship between the electronic device 102 and the central processing system 110 of FIG. 1, is now described. As discussed above, the system of FIG. 1 is operable to transfer transaction information from the electronic device 102 to the management server 132, PSP 106, PCP 104, and PoS terminal 108, and from the management server 132, PSP 106, PCP 104, and PoS terminal 108 to the device 102. FIG. 4 illustrates at a high level a flow of information between elements of the system 100 of FIG. 1.

As shown in FIG. 1, the central processing system 110 comprises a management server 132 connected to a database. It is to be appreciated that the database is a generic label used for the storage of information and so may also be referred to as a ‘data store’. FIG. 3 shows the central processing system 110 in communication with the electronic device 102 and PSPs. The central processing system 110 comprises an application programming interface 136 (API). The API 136 communicates with both the electronic device 102 of the user and a plurality of PSPs and may be implemented entirely in software running at the central processing system 110 in most embodiments. The API 136 enables the PSPs and electronic device 102 to communicate with the database and end points, herein referred to as ‘engines’, of the management server 132. The management server 132 comprises at least a user registration engine 138, labelled ‘/user’, a user preferences engine 140, labelled ‘\preferences’, and a notifications engine 142, labelled ‘notifications’. Each engine communicates with a specific part of the database 134: the user registration engine 138 is able to read and write data to a user registration part of the database 134; the user preference engine 140 is able to read and write data to the user preference part of the database 134; and the notifications engine 142 is able to read data from a transactions part of the database 134. The management server 132 receives inputs from the electronic device 102 relating to user registration data and user preference data at the user registration and user preference engines 138, 140 respectively. The engines then create new entries or update existing entries in the relevant parts of the database 134. The user preferences engine 140 is also in direct communication with the notifications engine 142.

The PSPs communicate with the management server 132 via the API 136 by writing data relating to transactions to a transactions database 148. The data typically comprises a token and an indication relating to an authorisation response at least, i.e. the outcome of the transaction, as will be described below in more detail. Other data such as merchant ID, basket ID, and basket value may also be included in the data. The notifications engine 142 is capable of reading the new data in the transactions database 148, receiving data relating to user preferences from the user preference engine, and then generating and outputting control signals or control data to the electronic device 102 in dependence of the transaction data and the preference data. The control signals or data compel or request the electronic device 102 to play/provide relevant feedback.

The initial process of downloading the application, installation, and registration of a user will now be described with reference to FIG. 3. The process relating to making a transaction using the digital wallet is described later with reference to FIGS. 1 to 4.

The user initially downloads the consumer application 128 to their electronic device 102 and installs the consumer application 128. Installation allows the consumer application 128 to interact with and control the device 102 to perform its desired function, when the consumer application 128 is run on the controller 114.

After installation of the application, the user registers personal details using the application interface. These details are used for identification purposes and for subsequent authentication requests. In FIG. 3, this is included in the icon labelled ‘user input’.

The user enters personal details via the application interface and the details are encrypted by the consumer application 128/electronic device 102. The details are communicated to the central processing system 110, which receives the details at the management server 132 via the API 136. The management server 132 receives information at its API 136. The management server 132 then decrypts the details and creates a user profile in the user database 144. If a user profile already exists for that user, the existing profile may be updated instead. Although only a single electronic device 102 is depicted here, it will be appreciated that more than one electronic device will be able to communicate with the management server 132 via the communications network 112 at any time.

As the management server 132 and database are on-demand services, the electronic device 102 requires a connection to the communications network 112, such as an internet connection, for the user to be able to interact fully with the application. Where a device cannot connect to the management server 132, then the application is still be able to perform much of its functionality with only locally cached media. It is noted however that, when the device 102 is disconnected from the communications network 112, changes to preferences are not saved to the central server and so these changes may not persist in such a situation, or may only persist once the device 102 is reconnected to the communications network 112.

When a connection to the communications network 112 (i.e. an internet connection) and connection to the management server 132 are established, the personal details of the user are encrypted using an encryption module (not shown) and persisted in the management database 134 as described above. In the event of no connection being available, the user will not be able to register to the service. In the case of FIG. 3, this is illustrated as the flow of information from the user device 102 to the user registration engine (‘\user’) 138 of the management server 132 using the API 136. The user registration engine transfers this data to the user database 144 for storage and later recall. For simplicity, FIG. 3 shows the API 136 to include the user, preference and transactions databases 138, 140, 142. However, it will be appreciated that, in practice, the data is in these databases 138, 140, 142 is stored in the central processing system database 134 which the API accesses, and the database 134 is not part of the API.

This process is also depicted in FIG. 4, labelled as the ‘user register’ flow arrow 150 between the consumer application 128 and the management server 132.

After registration, the user can enrol at least one payment card with the consumer application 128, here labelled as arrow 152. The payment card may be enrolled based on an existing payment card in an existing digital wallet application 130 (if the consumer application 128 is integrated or capable of interaction with the digital wallet application 130), or the payment card may be enrolled based on a scan of or manual entry of data on the payment card. The payment card may be a new payment card, and the consumer application 128 may have the functionality to enrol the payment card in the digital wallet application 130, optionally simultaneously and automatically.

To enrol the payment card, at least a Primary Account Number (PAN) for the card, and optionally an expiry date and/or other account or card details, are provided as inputs to the consumer application 128. To register that payment card with the system 100, the user's consent to the terms of service of the system is requested in a two-stage agreement. When consent and a network connection is present, the card information, including PAN and any other relevant card data, is encrypted at the electronic device 102. The encrypted data is communicated securely to the relevant PSP 106 via the communications network 112. The PSP 106 enables communication with it by external parties using APIs that link to a card data vault or database. The communication of the encrypted card information may be direct from the device 102 to the PSP 106 (not shown in FIG. 4) or via the management server 132 (of the central processing system 110), The management server 132 is incapable of decrypting the encrypted details.

The PSP 106 decrypts the encrypted PAN and any other card information, and generates a card identifier (CID). The PAN and other card information is then stored in a card data vault (not shown) of the PSP 106. The CID, or token, is a non-sensitive data equivalent used to refer to the card so that reference can be made to it without any sensitive information being transferred via non-encrypted communications. The PSP 106 encrypts and securely returns the token, either back to the electronic device 102 or to the management server 132.

The above assumes that the PSP 106 includes a tokenization service such as the Visa Token Service, which is part of Visa®, a PSP 106. In other embodiments, the token may be generated a token service separate from the relevant PSP 106, and communicated between the token service and the PSP 106 either directly or via the electronic device 102 again so that the PSP 106 generates or updates an entry in a card data vault.

The communication between the PSP 106 and the central processing system 110 also ensures that the PSP 106 will return information relating to transactions to the central processing system 110. The entry for the token in the PSP 106 vaults specifies communication with the management service when a transaction is authorised. A record of each authorised transaction is also stored at the management server 110.

If the token was communicated to the electronic device 102, the token, at least, is subsequently transferred from the consumer application 128 operating on the electronic device 102 to the central processing system 110. At this point, the consumer application 128 may communicate additional data such as user-specific data or assets, although it will be appreciated that this information may be communicated to the central processing system 110 by the electronic device 102 at any time. For example, a truncated version of the PAN, the token, and a user ID may be transferred from the application to the management server 132.

The central processing system 110 confirms to the electronic device 102 that the data has been received. A confirmation may be communicated to the user.

Once the central processing system 110 has received the token at its communications server, the user accounts engine of the central processing system 110 stores the token in the user accounts database for subsequent use.

The card enrolment process is then complete, and the user is prompted to enrol more cards, in which case the process repeats until the user has finished enrolling payment cards.

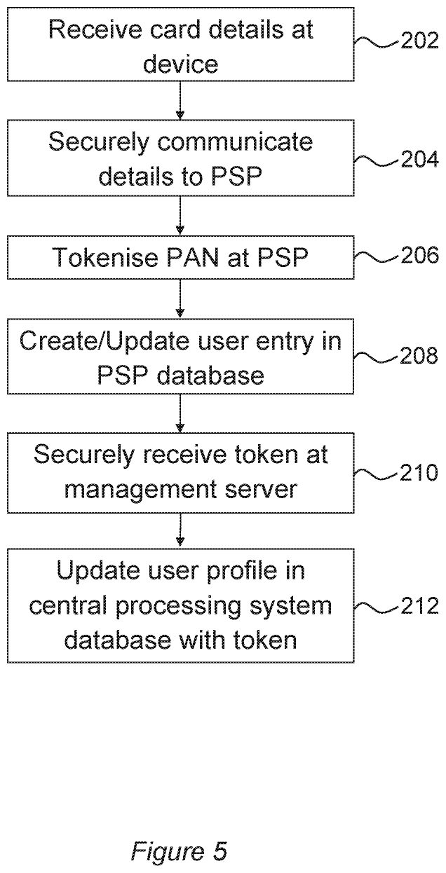

In general, therefore, the card enrolment process is performed according to the flow chart of FIG. 5. The process comprises the steps of: receiving card details at the electronic device 102; securely communicating the details to a PSP 106; tokenising the PAN at the PSP 106 to create token, also referred to as card identifier (CID); creating or updating a user entry with the token and PAN in a PSP 106 database to enable look-up; securely receiving the token from the PSP 106 at the management server 132; and updating a user profile with the tokenised PAN and any other relevant card data.

Having enrolled a payment card, user preference data for that card can be specified. The user may specify feedback preference data based upon feedback data stored in the database of the central processing system 110, or may specify feedback, such as ringtones, audio files, or other audio or haptic feedback data, stored on the electronic device 102.

The electronic device 102 encrypts the preference information before communicating it to the central processing system 110, where it is processed by the management server 132. The management server 132 utilizes the preference information to update the user's profile in a user accounts part of the database and to access the relevant data that corresponds to the user's preference. If this is successful, the communications server issues a confirmatory response to the electronic device 102.

As can be seen in FIG. 4, the management server 132 communicates 154 with the PSP 106, to update metadata associated with the payment card, so that when a transaction is made using that card, a chain of authorisation requests between the digital wallet, merchant, PSP 106, and PCP 104 takes place, and in addition to these, the PSP 106 also communicates 168 the authorisation response to the management server 132 including any metadata associated with the particular card used in the transaction. This update notification is depicted in FIG. 4 as arrow 154.

The PSP 106 may communicate this metadata update back to the digital wallet application, as depicted by arrow 156.

When a transaction is initiated, the user brings the electronic device 102, with NFC enabled, towards the NFC reader. The digital wallet application 130 communicates with the NFC reader at the PoS terminal 108, depicted by arrow 158. An authorisation request 160 is communicated to the PSP 106. The PSP 106 communicates an authorisation request 162 to the PCP 104. The PCP 104 responds with an authorisation response 164. The PSP 106 communicates the authorisation response 166 to the PoS terminal 108. The PoS terminal 108 communicates the authorisation response 170 to the digital wallet, and the user is shown an authorisation message. It will be appreciated that, although not shown in FIG. 4, additional authorisation request and response steps are also included in standard transactions. The communication between the PSPs and the issuer may be via an acquirer and payment schemes.

At the same time or at substantially the same time as communicating the authorisation response 166 to the PoS terminal 108, the PSP 106 also communicates an authorisation response 168 to the central processing system 110. The authorisation response 168 includes the token, any associated metadata, and other data typically found in an authorisation response. The token allows the management server 132 to identify the relevant electronic device 102 and payment card, while the authorisation response permits identification of the outcome of the transaction, i.e. whether the transaction was successful or unsuccessful. The metadata enables identification of the user's particular preferences, or may be useful to the consumer application 128 to identify the correct notification to feedback. The authorisation responses 166, 168 communicated from the PSP 106 to the PoS and from the PSP 106 to the central processing system 110 are substantially the same authorisation responses, although it will be appreciated that different authorisation responses may be used in other embodiments.

The management server 132 identifies the electronic device 102 based on the response, and communicates with the consumer application 128 via the communications network 112 to control or request the application to provide the relevant PoS feedback according to the user's indicated preferences and/or any other data, such as the metadata, provided according to the transaction data. This is depicted in FIG. 4 as arrow 172. Accordingly, the electronic device 102 receives the request, and, using the information provided, and via the consumer application 128, causes the electronic device 102 to produce feedback by activating and operating the loudspeaker 124, vibration generator, and/or other haptic, audio, or vibration feedback generator. The electronic device 102 may, via its digital wallet application 130, also play conventional feedback, or the digital wallet application 130 may be overridden by the consumer application 128 if the two are capable of integration.

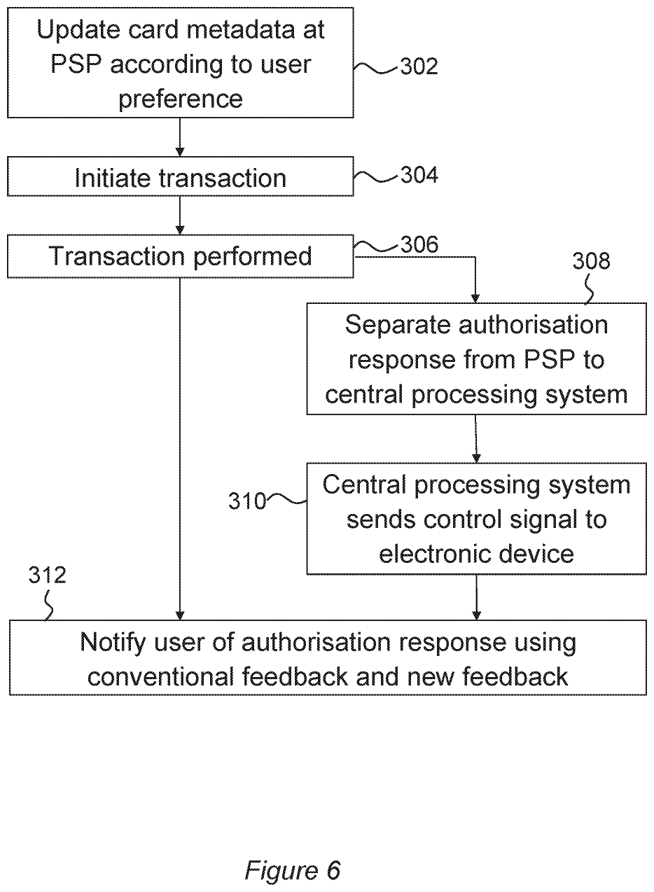

Generally, therefore, the process may be depicted as a flow chart, such as the flow chart shown in FIG. 6. The process of implementing the user-selected feedback during a transaction, as shown in FIG. 6, initially comprises the step of updating card metadata in the PSP 106 according to user preferences so that the PSP 106 sends the authorisation response to the central processing system 110 as well. Of course, once the card metadata has been updated once, this step is no longer essential, and so may be excluded as strictly optional. A transaction is then initiated, and the transaction process, including the conventional string of communications and interactions between components is performed. The string of authorisation requests reaches the PCP 104, and the string of authorisation responses is communicated back to the digital wallet application 130 in the usual way (as shown in FIG. 4). The method also comprises a split in the process, where a separate authorisation response, or specific data relating to the authorisation response, is sent from the PSP 106 to the central processing system 110. On this branch of the method, the central processing system 110 sends a control signal to the electronic device 102. Finally, both branches converge as the user is notified of the authorisation response at the electronic device 102 and NFC reader of the PoS terminal 108 using a mixture of conventional feedback and new feedback. For example, the conventional feedback may be the illuminating of lights on the NFC reader and a confirmatory message displayed on either or both of the NFC reader and the electronic device 102. The new feedback, as described herein, is an audio, haptic, and/or vibratory feedback signal.

As can be seen in FIG. 6, the conventional transactional process is undisturbed by the new parts of the process and is performed as normal. The difference lies in the introduction of the central processing system 110 and its interaction with the legacy system used to perform the transaction. The flow of information between the central processing system 110 and the PSP 106 advantageously enables a greater variety of customisation of feedback to improve a user experience when paying for goods or services using a digital wallet. Also all of this functionality can in this embodiment be retrofitted to an existing contactless point of sale authorisation process thereby minimising cost and effort in implementation.

The communication of this authorisation response to the management server 132 of the central processing system 110 allows a custom notification to be provided to the user as opposed to the standard, non-customisable, and non-specific feedback provided by the digital wallet application 130. Advantageously, the provision of a separate processing system to enact these notifications ensures that both the transaction made using the digital wallet and digital wallet application 130 and the notification provided by the consumer application 128 are as swift as possible and that there is no uncertainty about the information that has been communicated both ways.

A user can set their unique user preferences at any time after payment cards have been enrolled with the consumer application. The preferences are used to determine point-of sale feedback, and in particular, which audible or vibratory notifications under which circumstances will be performed. More specifically, the user can associate specific response profiles with specific meanings and these can be stored centrally on the management server. The notification sound or vibration feedback may indicate at least one of: transaction status; the number of transactions made within a time period; value of the transaction; cumulative value of transactions made within a time period; frequency of transactions made within a time period; data relating to a customer reward scheme; and indication of a threshold value being reached in relation to: number of transactions; frequency of transactions; or cumulative value of transactions. For example, the user can associate three different response profiles with three different feedback meanings.

Response profiles can be created within the application using a profile activity. This activity will provide user-selectable patterns of audible and vibration feedback that a user can associate with a given feedback (number of transactions, transaction amount threshold etc.) as listed above. The user may select an option allowing merchants, PSPs, PCPs, or other third parties to play a notification on the device in response to making a specific purchase.

The management server 132 is configured to communicate with the consumer application 128 to ensure that the correct notification files, such as sound files or vibration feedback signals are stored on the electronic device 102 to enable quick recall when required. The sound files may be stored as WAV files for example.

These preferences include the default transaction notification sound and default transaction vibration feedback associated with the card and the rules for smart notifications. For example, when a user uses the digital wallet to make a plurality of transactions over a predetermined time period, a particular notification may be used when the user makes the ‘Nth’ transaction and thereby reaches a threshold transaction. This threshold may be set by the merchant to identify when the user qualifies for a loyalty reward, or by the PSP or PCP to reward the customer for spending using their card or platform. The threshold and cumulative transaction value would be calculated and compared by the management server following each transaction.

Alternatively, the user may pre-set a transaction limit threshold and a specific notification that corresponds to an exceedance of this threshold.

The notification may alternatively relate to an authorisation result.

In some embodiments, the frequency of transactions made within a particular predetermined time period may result in a specific notification, or the number of transactions made during that period may be associated with a notification. The notification may be particular to a specific merchant, PSP or PCP, or may be related to a transaction status.

In some circumstances, the consumer application may ‘gamify’ the data, requiring the user to make specific transactions for a specific notification to be played or accessible.

It will be appreciated that multiple notifications may be enacted simultaneously or consecutively if a number of rules or preferences have been set.

It is envisaged that once the user has set their preferences, the consumer device will download the notification data selected by the user and store it in the device memory for recall later. If the user preferences change, the notification data is replaced with new data. The notifications engine 142 is configured to prompt the device to access the data and communicate this following a transaction.

In some embodiments, the sound may also be associated with an image displayed on the device display when a transaction has occurred.

In some embodiments, the notification may be made by the digital wallet application rather than the consumer application. In this case, the digital wallet accesses the notification directly from the management database and stores it in the local device memory.

In embodiments described herein, there is provided herein a system for managing transaction metadata, audio data and notification preferences applied to transactions carried out using a digital wallet. The system may comprise an electronic device, such as a mobile telecommunications device, which is associated with an end user. The end user may be a consumer. The electronic device typically comprises a processor and an input means. Optionally, the electronic device may comprise a memory for storing processed audio and metadata. The electronic device may comprise a communications module operable to download a consumer application. Preferably, the communication module is a wireless telecommunications module. The system may comprise a management server configured to receive user preferences from the electronic device. The system may also be configured to receive an authorisation response from a payment service provider, and, in response to receiving the authorisation response and based on user preferences, to transmit a command or notification to the electronic device to communicate a feedback signal to a user.

The consumer application may comprise at least one of: a user interface; a registration interface; a ‘wallet’ interface of payment card entries; payment card identification software; a library of available audio for notification and status; and a preferences interface for making selections.

The electronic device may be arranged to execute the downloaded consumer application to control the electronic device to carry out at least one function, method and/or operation as per the embodiments described herein.

Moreover, the electronic device may be arranged to execute the downloaded consumer application to control the electronic device to perform a set of actions, the set of actions comprising at least one of; make an NFC transaction using a digital payment wallet; playing distinct notification sounds when an NFC transaction has occurred; providing distinct notification vibratory feedback when an NFC transaction has occurred.

The notification sound (audio) or vibration feedback may indicate at least one of: transaction status; the number of transactions made within a time period; value of the transaction; cumulative value of transactions made within a time period; frequency of transactions made within a time period; data relating to a customer reward scheme; and indication of a threshold value being reached in relation to: number of transactions; frequency of transactions; or cumulative value of transactions.

The application may be sourced from an application store and/or content provider. For example, the content provider may comprise the Apple® Appstore®. The content provider may comprise a cloud computing provider.

The input means of the electronic device may comprise user-input apparatus arranged to receive an input from a user. In some embodiments, the user input apparatus may comprise a touch sensitive display screen. Advantageously, this allows a user to input data to the electronic device.

Preferably, the consumer application comprises a graphical user interface (GUI). The graphical user interface may comprise user-interactable artefacts such as buttons.

Preferably, the user-interactable artefacts may be displayed on the screen and receive a user input for selection or control of those artefacts. The electronic device may be controlled to selectively hide those artefacts in dependence on the state of the electronic device.

Preferably, the electronic device is controlled by the consumer application to provide feedback about payment transaction data.

The system may further comprise of at least one of; a management server comprising at least one of; a user registration engine; an encryption module; a decryption module; a payment card provider; a management database comprising at least one of; a library of audio media for notification alerts; a payment card truncated PAN; and token data.

There is provided herein a method for managing transaction metadata, audio data and notification preferences applied to transactions carried out using a digital wallet. The method may comprise performing a transaction using the digital wallet, receiving, at an electronic device acting as the digital wallet or at a management server in communication with the electronic device, a notification that a transaction has been successful, and communicating a feedback signal to a user based on user preferences.

While the above embodiments are related to payment systems and transactions using dig wallets, it will be appreciated that the overall teaching is also applicable to other forms of payment transactions, and a wider set of interactions between two devices.

In some embodiments, there is provided a system for providing improved feedback to a user during a contactless interaction between a first device and a second device. In some embodiments, both devices are near-field devices capable of near-field communication and the interaction is a near-field interaction. In the embodiments described above, the first device is an electronic device such as a smartphone acting as a digital wallet, and the second device is an NFC reader. In other embodiments, the first near-field device may be an NFC reader, and the second device may be a payment card with contactless payment capabilities. It is to be appreciated that in such an embodiment there is no digital wallet provided as the payment card has a unitary function to enable payments and is not a electronic telecommunications device. In yet further embodiments, the first device may be a chip-and-PIN device, or other PIN entry device, while the second device may be a payment card. Outside the field of payment transactions, the first device may be a processing system and the second device may be a token, such as a loyalty processing system and a loyalty token, or an NFC reader configured to permit access through a locked door and an identification token.

In the system according to the above described embodiments, at least one of the first device and the second device is associated with a specific user. For example, the information contained in the digital wallet, or payment card is associated with the user and specific to that user. In general in systems of this type, the specific tokens, such as payment cards, digital wallet are unique to the user and enable identification of the user within the system.

Generally, the system comprises a processing system connected to a communications network, and configured to communicate with at least the first near-field device via the communications network. As will be appreciated, the communications network may be the Internet as described above, or an internal network. The processing system may be configured to perform a method. The method described by the above embodiments comprises: receiving data relating the interaction, the data including at least an outcome of the interaction and information identifying the user; determining, based on the received data, user data associated with the user; generating a control signal based on the outcome of the interaction and the determined user data, the control signal configured to cause at least the first device to generate user-associated data-dependent and/or outcome-dependent feedback; and outputting the control signal to at least the first device.

In the context of payment systems, the receipt of data relating to the outcome of the interaction is typically the authorisation response received from the PCP at the PSP, the information identifying the user is information included in the authorisation response relating to the transaction, and the control signal is generated at the central processing system based on the metadata and transactional data received from the PSP. Alternatively, where the central processing system accesses metadata based on the received token, the receipt of data relating to the outcome of the interaction is the authorisation response communicated from the PSP to the processing system, the information identifying the user is the token of the PAN, and the control signal causes the electronic device to generate audio feedback based on the outcome and on the user data, typically a preference or information related to the interaction or their account. In some aspects, the electronic device or a payment card may be the second device, so that the NFC reader or PIN entry device is the first device. In this respect, the central system may cause the NFC reader to play a different sound that depends on the electronic device owner, who may be considered to be the user, or a sound that depends on the NFC reader owner, i.e. the merchant, who may also be considered to be a user. In this case, the sound may be a thank you message from the merchant, or even from the PSP or PCP.

It will be understood that features, functions and advantages of this aspect of the present invention may be combined or substituted where context allows. Furthermore, features described herein may themselves constitute further aspects of the invention. For example whilst the contactless and wireless communications of the above described embodiments use NFC technology, it is possible that other forms of contactless technology could be used namely others based on short-range communications protocols such as Bluetooth® for example or other inductive technologies which do not conform to the NEC standard.

1. A method for providing improved feedback to a user during an electronic contactless interaction between a first contactless device and a second contactless device, wherein at least one of the first contactless device and the second contactless device is associated with a specific user, the method comprising:
receiving interaction data relating to the electronic contactless interaction, the data including at least an outcome of the contactless interaction and information identifying the user;
determining, using the received interaction data, user preference data associated with the user;
generating a control signal based at least on the outcome of the electronic contactless interaction and on the user preference data, the control signal configured to cause at least the first contactless device to generate feedback in dependence on the outcome and the user preference data; and
outputting the control signal to at least the first contactless device.

2. The method of claim 1 comprising, prior to the electronic contactless interaction, receiving a user selection relating to user preference data and associating the user preference data with a user entry in a data store, and wherein determining the user preference data comprises receiving the user preference data from the data store.

3. The method of claim 2, wherein the data store is an external data store, and wherein the user preference data is received with the interaction data.

4. The method of claim 2, wherein the data store is a local data store, and wherein receiving the user preference data from the data store comprises accessing the data store and identifying user preference data based on the information identifying the user.

5. (canceled)

6. The method of claim 1, wherein the electronic contactless interaction is a contactless payment transaction and wherein the step of receiving interaction data comprises receiving an authorisation response that includes the data relating to the electronic contactless interaction.

7. The method of claim 6, wherein the step of receiving interaction data comprises receiving information identifying the user in the form of a payment card identifier, and wherein the determining step comprises comparing the payment card identifier with stored data relating to a plurality of users and identifying the user-data corresponding to the payment card identifier.

8. The method of claim 7, wherein the step of receiving interaction data comprises receiving information identifying the user in the form of a PAN (Primary Account Number), a truncated PAN, or a tokenised PAN.

9. The method of claim 6, wherein the method includes providing improved feedback to a user during an electronic contactless interaction between the first and second contactless devices, where the first and second contactless devices comprise near-field communication (NFC) devices.

10. The method of claim 9, wherein the first contactless device comprises an electronic device configured to operate as a digital wallet and the second contactless device comprises an NFC reader connected to a wider payment system.

11. (canceled)

12. The method of claim 9, wherein the first contactless device comprises an NFC reader connected to a wider payment system, and the second contactless device comprises a contactless payment card.

13. The method of claim 1, wherein the generating step comprises generating a control signal configured to cause at least the first contactless device to generate feedback in the form of audio and/or haptic feedback.

14. The method of claim 1, further comprising receiving the control signal at the first contactless device and generating the feedback according to the control signal.

15. The method of claim 14, wherein the step of generating the feedback according to the control signal comprises identifying data stored locally on the first contactless device based on the control signal and generating feedback using the identified data.

16. The method of claim 1, further comprising initiating the electronic interaction between the first and second devices, and receiving the data relating to the electronic contactless interaction during the interaction.

17. The method of claim 1, wherein the generating step comprises generating a control signal configured to cause at least the first contactless device to generate feedback in the form of audio and/or haptic feedback, feedback being in an encoded form the meaning of which the user understands from the user preference data.

18. A system for providing improved feedback to a user during an electronic contactless interaction between a first device and a second device, wherein at least one of the first device and the second device is associated with a specific user, the system comprising:
a central processing system operatively connected to a communications network, and configured to:
communicate with at least the first device via the communications network;
receive interaction data relating to the electronic contactless interaction, the data including at least an outcome of the contactless interaction and information identifying the user;
determine, using the received interaction data, user preference data associated with the user;
generate a control signal based at least on the outcome of the electronic contactless interaction and on the user preference data, the control signal configured to cause at least the first contactless device to generate feedback in dependence on the outcome and the user preference data; and
output the control signal to at least the first contactless device.

19. The system of claim 18, further comprising the first device operatively connected to the communications network and configured to communicate with the central processing system and to generate feedback in dependence on the control signal.

20. The system of claim 18, further comprising at least one payment processing system, the payment processing system operatively connected to the communications network and configured to communicate with at least the central processing system and to communicate the data relating to an electronic interaction to the central processing system.

21. The system of claim 20, wherein the payment processing system and central processing system are separate.

22. (canceled)

23. An electronic device for providing improved feedback to a user during an electronic contactless interaction between the device and another device, the electronic device comprising:
an application for generating an electronic wallet;
a processor configured to interact with the central processing system of claim 18;
a receiver for receiving the control signal; and
a generator for generating an audio and/or haptic response in accordance with the received output control signal.
